(19) United States
(12) Patent Application Publication
(10) Pub. No.: US 2025/0061054 A1
(43) Pub. Date: Feb. 20, 2025

(54) Testing of Automation Applications

(71) Applicant: Siemens Aktiengesellschaft, Muenchen (DE)

(72) Inventors: Alexander STEIN, Veitsbronn (DE); Matthias FRANK, Erlangen (DE); Michael BAIERLEIN, Spalt (DE); Dominik BUDDAY, Erlangen (DE)

(21) Appl. No.: 18/802,559

(22) Filed: Aug. 13, 2024

(30) Foreign Application Priority Data
Aug. 18, 2023 (EP) 23192215

(51) Int. Cl. G06F 11/36; G05B 19/05

(52) U.S. Cl. CPC G06F 11/3664; G05B 19/058

(57) ABSTRACT

Device and method for testing automation applications in a manner that improves the testing of the automation application, wherein data of an automation language for a test environment is processed, where the test environment includes a test environment for the actual system of the automation application and/or for at least one simulation of the automation application, and where at least one test of the test environment is performed such that. It is that the improved testing advantageous enables a safer automation solution.

### BACKGROUND OF THE INVENTION

### 1. Field of the Invention

The invention relates to an device and method for testing automation solutions.

### 2. Description of the Related Art

In automation solutions, it is important to also be able to test application programs for their safety. For example, the intent may be to prevent an industrial robot from performing movements into a safety-critical area, thereby endangering people or damaging machines or equipment. The increasing complexity of automation solutions is making this increasingly difficult. For example, when implementing complex processes and movements by machines, their overrun safety must also be ensured. In the course of this, programs should be tested and certified under safety-relevant aspects.

As part of such a test, it is necessary to perform and create complex tests. This is often performed by manually entering different test scenarios. This is cumbersome, time-consuming, and often limited to a subset of the relevant scenarios.

A specific problem is that the application programs of the automation solutions are defined in an “automation language” that has limitations in terms of flexible and comprehensive testing.

For the purposes of the present comments, “automation languages” particularly include programming languages for programmable logic controllers, such as those specified for example (but not exhaustively) in the EN 61131-3 standard, including: instruction list (STL), contact plan (KOP), function block language (FBS, also known as function diagram (FUP) or STEP 7), sequence language (AS) or structured text (ST).

In this case, the automation languages are distinct from “higher programming languages”, such as Java, C, C++, JavaScript, C#, Python, and/or PHP.

### SUMMARY OF THE INVENTION

It is an object of the invention to provide a method for improved handling of application programs for automation solutions, in particular for safety-relevant applications.

This and other objects and advantages are achieved in accordance with the invention by a method for testing an automation application, in which data from an automation language for a test environment is processed, where the test environment includes a test environment for the actual system of the automation application and/or for at least one simulation of the automation application, and where at least one test of the test environment is performed.

For example, the automation application comprises a real automation solution or a simulation of the automation solution. The automation solution, for example, is an automation system and comprises, for example, automation units, such as manufacturing machines and/or robots.

In one embodiment, the data of the automation language comprises elements or modules of the automation language, which are provided to the test unit.

In another embodiment, the automation language is a programming language for programmable logic controllers, in particular a programming language according to or based on the 61131-3 standard.

In a further embodiment, the data of the automation language for the test environment is processed in accordance with at least one of the following actions:
extraction of input/output variables for the test environment;
adaptation of data types;
generation of test classes based on the data of the automation language.

In another embodiment, the data of the automation language for the test environment is processed based on additional reference data.

In a still further embodiment, the data of the automation language for the test environment is processed based on additional reference data in accordance with the following action:
the data is mapped to permissible values or value ranges using the reference data, wherein in particular an adjustment can be made based on data types.

In another embodiment, a validation is performed by comparing the actual system of the automation application with the at least one simulation of the automation application.

In a further embodiment, a validation is performed by comparing at least two simulations of the automation application with one another.

In yet another embodiment, elements of the automation language are converted into a program of a higher programming language and at least one simulation of the test environment is generated or modified by means of the program.

In a further embodiment, the program is tested.

The objects and advantages are also achieved in accordance with the invention by a device for testing an automation application, comprising a processing unit, where the processing unit is configured to perform the method in accordance with the disclosed embodiments.

The processing unit mentioned here may be embodied, in particular, as a processor unit and/or an at least partially hard-wired or logical circuit arrangement, which is configured, for example, such that the method in accordance with the disclosed embodiments can be performed as described herein. The processing unit can be or can comprise any type of processor or calculator or computer with the necessary peripheral devices (e.g., memory, input/output interfaces, and/or input and output devices).

The above explanations relating to the method accordingly apply to the apparatus. The apparatus may be in one component or distributed in a plurality of components.

The objects and advantages are also achieved in accordance with the invention by a system comprising at least one of the apparatuses described here.

The objects and advantages are also achieved in accordance with the invention by a device for testing an automation application, where the device comprises a test unit and a test environment, where the test unit is configured to process data of an automation language for the test environment, where the test environment includes a test environment for the actual system of the automation application and/or for at least one simulation of the automation application, and where the test environment is further configured to implement at least one test.

The objects and advantages are also achieved in accordance with invention by a computer program product, which can be loaded directly into a memory of a digital computer, comprising program code parts which are suitable for carrying out steps of the method described here.

The objects and advantages are also achieved in accordance with the invention by a computer-readable storage medium, for example, any desired memory, comprising instructions (for example, in the form of program code) that can be executed by a computer and that are suitable for the computer to implement the method in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which they are achieved become more clearly and distinctly comprehensible in connection with the following schematic description of exemplary embodiments which are explained in more detail in connection with the drawings, in which:

FIG. 1 shows a schematic diagram illustrating the generation of data for performed a test of an automation solution

FIG. 2 shows a block diagram based on FIG. 1 with an extended test environment;

FIG. 3 shows a block diagram based on FIG. 2 with extended testing capabilities; and

FIG. 4 is a flowchart of the method in accordance with the invention.

### DETAILED DESCRIPTION OF THE EXEMPLARY EMBODIMENTS

Identical or identically acting elements can be provided with identical reference symbols for the sake of clarity.

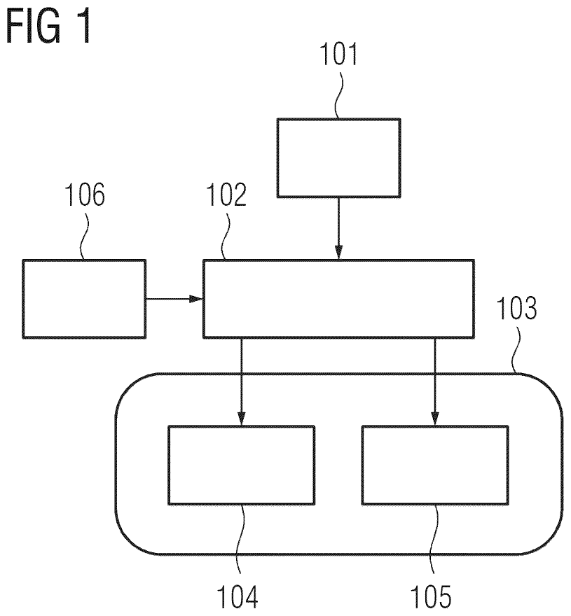

FIG. 1 shows a schematic diagram illustrating the generation of data for performing a test of an automation solution. The automation solution can include a plurality of automation units, e.g., manufacturing machines, and/or robots.

A block 101 contains elements of an automation language. As mentioned above, this can be an automation language in accordance with the EN61131-3 standard or a similar automation language. For example, the elements of the automation language define a library of instructions (e.g., an FUP library). The elements of the automation language can be provided in the form of modules, where each module comprises at least one function (function block, function call) and/or at least one series of instructions.

Furthermore, FIG. 1 includes a test unit 102. For example, this is a test suite for at least one test performed on a test environment 103.

The test environment 103 can include the real system 104 (i.e., the specific automation solution) and/or (at least) a simulation 105 of the real system.

The test unit 102 is used to prepare the at least one test in the test environment 103. This preparation in the test unit 102 comprises, for example, extraction and/or preparation of information based on data provided by the block 101. In particular, the provision can be a query of the data initiated by the test unit 102.

For example, the data is delivered from block 101 to the test unit 102. For this purpose, elements of the automation language from block 101 can be transmitted to the test unit 102. For example, the data can be provided in an Extensible Markup Language (XML) format.

Based on the data received, the test unit 102 extracts information that can subsequently be used in the test environment 103.

Optionally, the test unit 102 processes the data by including reference data 106. The reference data 106 may be part of the test unit 102 and/or be provided by a separate unit. For example, the reference data 106 includes (ranges of) values for the variables extracted by the test unit 102. Expected values, e.g., for modules, can also be part of the reference data 106.

The processing of the data provided by block 101 and optionally of the reference data 106 on the test unit 102 includes at least one of the following actions:
(1) Input/output variables relevant to the test environment 103 are extracted; for example, these may be external variables that are visible to the outside and affect the test environment 103, whereas internal (local) variables of the elements of the automation language may optionally be omitted. In one example, external variables could be distinguished from internal variables, for example, by using the declaration part of the automation language. For example, these variables are suitable for assessing a test as successful (or possibly also unsuccessful).
(2) Data types can be adapted. For example, data types of the automation language can be adapted in data types of the test environment 103.
(3) The extracted variables can be mapped onto permissible values or value ranges using the reference data 106. An adaptation based on different data types can also be performed.
(4) The processing of the data (optionally taking the reference data 106 into account) is module-related, i.e., depending on modules defined in the block 101. In particular, it is possible that modules are recognized as such and converted (prepared) for the test environment accordingly. For example, such a conversion may comprise mapping an existing class in F-FUP with the associated methods and variables, so that verification is possible during test execution (of the test environment 103).
(5) Based on the data of the automation language, test classes are generated.

Thus, the test unit 102 delivers information (in the form of data) to the test environment 103, which is used to implement tests on the real system 104 and/or on the simulation 105.

This makes it possible in an efficient manner to prepare, i.e., in particular to determine and initiate or perform, an automated test, optionally using reference data, based on elements available in an automation language and to check the results.

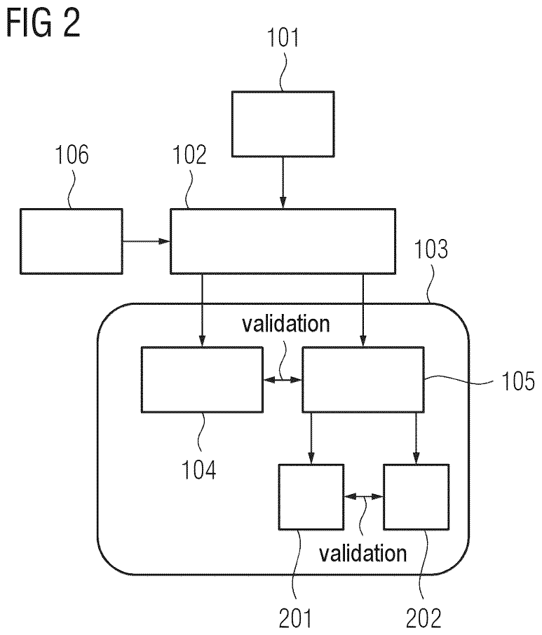

FIG. 2 shows a block diagram based on FIG. 1 with an extended test environment 103.

If the test environment 103 is determined via the test unit 102 in accordance with the above explanations, the real system 104 can be tested and simulation 105 can also be tested. Preferably, a comparison between the actions of the real system 104 and the (simulated) actions of the simulation 105 can be performed and a validation can be implemented based on discrepancies: if the real system 104 and the simulation 105 behave in the same way (within specified limits), then the validation can be verified, otherwise it will not be verified and a search for reasons for the discrepancy/ies can be initiated, for example.

The real system 104 can also include a reference implementation from the automation solution, for example, a test setup with automation units or parts of automation units.

The test environment 103 also allows the reference data 106 or parts of the reference data to be checked. For example, calibration ranges can be specified based on reference data 106, which are checked and, if necessary, verified in the test environment. Optionally, the reference data 106 is suitably prepared or transformed via the test unit 102, so that its use in the test environment 103 is possible.

It is also possible for different simulations based on the information determined by the test unit 102 to be performed as part of the simulation 105. In the present example, a SIMATIC PLCSim simulation 201 is performed and a simulation based on a software platform .NET 202.

Here, a comparison can also be made between the two simulation variants 201 and 202, i.e., it is possible to determine whether the actions of the simulation PLCSim 201 differ from actions of the .NET simulation 202 (the results differ, for example, by more than specified limits). In the event of such a discrepancy, the simulation variants 201 and 202 are not successfully validated. Otherwise, i.e., if the actions of the simulations (substantially) match, then the validation can be verified.

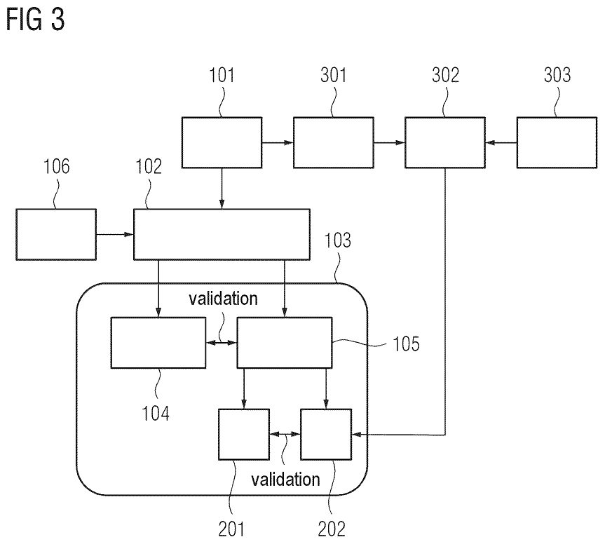

FIG. 3 shows a block diagram based on FIG. 2 with extended testing capabilities.

Firstly, the elements of the automation language (block 101) are transformed or translated via a converter 301 into a program 302 of a higher programming language. For example, modules of an FUP programming language can be translated into a C#program.

One advantage of the program 302 is that it can be subjected to known program tests and that known test libraries can be used to (systematically) examine the program 302 for errors. Another advantage is that reference values can be flexibly transferred to the program 302. These possibilities are indicated in FIG. 3 by an arrow 303.

The program 302 can now continue to be used to initiate a simulation, e.g., a .NET simulation 202. It is also advantageous that multiple different simulations can be launched based on the program 302.

It is also advantageous that the domain of the automation language according to block 101 is transformed via the conversion 301 into the domain of the higher programming language, where the additional capabilities of the higher programming language can be used flexibly for testing. This applies to the program code of the program 302 as well as the capabilities for handling the test environment 103.

Thus, during the validation of the different tests it is possible to determine whether the tests have the same deviations regarding the movements or paths of the movable parts of the automation units. The transformation into the program 302 additionally enables a more flexible, simplified and transparent verification of the software itself. This means that user programs can be tested or simulated on a modular basis or as a complete solution consisting of a plurality of modules.

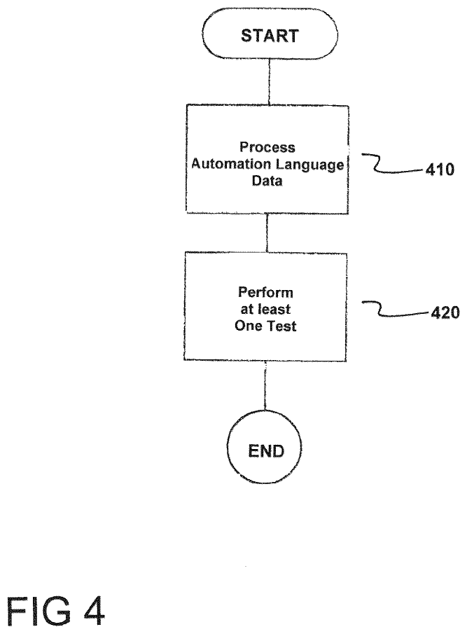

FIG. 4 is a flowchart of the method for testing an automation application. The method comprises processing data from an automation language for a test environment is processed, as indicated in step 410. Next, at least one test of the test environment is performed, as indicated in step 420.

In accordance with the method of the invention, the test environment includes either a test environment for an actual system of the automation application and/or at least one simulation of the automation application.

### Further Examples and Advantages

By validating the simulation, it is possible to save time and costs before commissioning the real system.

The approach proposed here simplifies engineering and testing and enables predictive, cost-effective maintenance by allowing changes in the real system to be detected before (expensive) damage occurs.

Although the invention was described and illustrated in more detail using the at least one exemplary embodiment shown, the invention is not restricted thereto and other variations can be derived therefrom by a person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for testing an automation application, the method comprising:
processing data from an automation language for a test environment is processed; and
performing at least one test of the test environment;
wherein the test environment includes at least one of a test environment for an actual system of the automation application and at least one simulation of the automation application.

2. The method as claimed in claim 1, wherein the data of the automation language comprises elements or modules of the automation language, which are provided to the test unit.

3. The method as claimed in claim 1, wherein the automation language is a programming language for programmable logic controllers, in particular a programming language according to or based on the 61131-3 standard.

4. The method as claimed in claim 1, wherein the programming language for programmable logic controllers is in accordance with or based on the 61131-3 standard.

5. The method as claimed in claim 1, wherein the data of the automation language for the test environment is processed in accordance with at least one of the following actions (i) extraction of input/output variables for the test environment, (ii) adaptation of data types and (iii) generation of test classes based on the data of the automation language.

6. The method as claimed in claim 1, wherein the data of the automation language for the test environment is processed based on additional reference data.

7. The method as claimed in claim 6, wherein the data of the automation language for the test environment is processed based on additional reference data in accordance with the following action: the data is mapped to permissible values or value ranges using the reference data, an adjustment being performable based on data types.

8. The method as claimed in claim 1, wherein a validation is performed by comparing an actual system of the automation application with the at least one simulation of the automation application.

9. The method as claimed in claim 1, wherein a validation is performed by comparing at least two simulations of the automation application with one another.

10. The method as claimed in claim 1, wherein elements of the automation language are converted into a program of a higher programming language and at least one simulation of the test environment is generated or modified via the program.

11. The method as claimed in claim 10, wherein the program is tested.

12. A device for testing an automation application, comprising:
a processing unit;
wherein the processing unit is configured to:
process data from an automation language for a test environment; and
perform at least one test of the test environment;
wherein the test environment includes at least one of a test environment for an actual system of the automation application and at least one simulation of the automation application.

13. A device for testing an automation application, comprising:
a test unit; and
a test environment;
wherein the test unit is configured to process data of an automation language for the test environment;
wherein the test environment includes a test environment for at least one of an actual system of the automation application and at least one simulation of the automation application; and
wherein the test environment is further configured to perform at least one test.

14. A computer program product, which is loadable directly into a memory of a digital computer, comprising program code parts for performing the method as claimed in claim 1.

15. A computer-readable storage medium encoded with program instructions which, when executed by a processor of a computer, enabling the computer to test an automation application, the program instructions comprising:
program code for processing data from an automation language for a test environment is processed; and
program code for performing at least one test of the test environment;
wherein the test environment includes at least one of a test environment for an actual system of the automation application and at least one simulation of the automation application.
